(19) United States
(12) Patent Application Publication
(10) Pub. No.: US 2006/0119578 A1
(43) Pub. Date: Jun. 8, 2006

(54) System for interfacing between an operator and a virtual object for computer aided design applications

(76) Inventors: Thenkurussi Kesavadas, Clarence Center, NY (US); Ameya Vasudeo Kamerkar, San Jose, CA (US); Ajay Anand, Williamsville, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/272,530

(22) Filed: Nov. 10, 2005

Related U.S. Application Data
(60) Provisional application No. 60/626,906, filed on Nov. 11, 2004.

(51) Int. Cl. G09G 5/08; G05B 15/00

(52) U.S. Cl. 345/161; 700/85

(57) ABSTRACT

An apparatus (15) for interfacing between an operator (26) and computer generated virtual object comprising a force sensor (19) that provides a force signal as a function of the amount of force applied to a representative physical body (22), a position sensor (18) that provides a position signal representative of the location of the position sensor when the force is applied, an article (16) for coupling the force sensor and the position sensor to an extremity of an operator, and a processor system (20) communicating with the force sensor and the position sensor and adapted to deform a virtual object (24) as a function of the force signal and the position signal.

### CROSS-REFERENCE TO RELATED APPLICATIONS

This application claims the benefit of U.S. Provisional Patent Application No. 60/626,906, filed Nov. 11, 2004.

### TECHNICAL FIELD

The present invention relates to systems for computer aided design and, more particularly, to an apparatus for interfacing between an operator and a virtual object.

### BACKGROUND ART

Research in geometric modeling has led to the development of many interactive and intuitive deformation methods for free-form curves and surfaces. NURBS have become the de facto industry standard for the representation, design, and data exchange of free form type geometric information. NURBS have been added to several international standards, and many commercial CAD packages include NURBS as a primitive for designing free form curves and surfaces. The NURBS paradigm is limited by the requirement that the surfaces are defined over rectangular domains, which leads to topological rectangular patches. Since control points, weights and knot sequences define a NURBS surface, modifications to these parameters produce a change in the shape of the surface.

Piegl et al. (Piegl, L., and Tiller, W., The NURBS Book, ISBN 3540-55069-0 Springer-Verlag Berlin Heidelberg, New York, 1995), the disclosure of which is hereby incorporated by reference, discussed a fundamental property of NURBS curves and surfaces, called the cross ratio, which quantifies the push/pull effect of weights for NURBS curves. Piegl et al. and Welch et al. (Welch, W., and Witkin, A., Variational Surface Modeling, Computer Graphics, Vol. 26, No. 2, pp. 157-166, 1992), the disclosure of which is hereby incorporated by reference, have also set forth various shape operator algorithms such as wrap, flatten, bend, stretch, twist and taper. Au et al. (Au, C. K. and Yuen, M. M. F., Unified Approach to NURBS Curve Shape Modeling, CAD, Vol. 27, No. 2, pp. 85-93, 1995), the disclosure of which is hereby incorporated by reference, proposed an approach for modifying the shape of NURBS curves by altering the weights and the location of control points simultaneously. The weights and control points are usually changed through user input from the keyboard and the mouse. However, such an approach does not allow for a more intuitive feel of the sculpting procedure.

Celniker et al. (Celniker, G., and Welch, W., Linear Constraints for Deformable Non-uniform B-spline Surfaces, Proceedings of the Symposium on Interactive 3D Graphics, pp. 165-170, July 1992) have developed a surface modeling system for interactively sculpting a free-form B-spline surface using a standard mouse and keyboard. The deformation behavior of the surface is modeled by minimizing a global energy functional which describes how much energy is stored in the surface for any deformation shape.

Thompson et al. (Thompson, T., Johnson, D., Cohen., E., Direct Haptic Rendering of Sculptured Models, Proceedings of the 1997 Symposium on Interactive 3D Graphics, pp. 167-176, 1997), the disclosure of which is hereby incorporated by reference, discloses a haptic rendering system for sculpting NURBS surfaces using a Sarcos force-reflecting exo-skeleton arm. The surface deforms based on the systems haptic rendering capability to generate forces applied to the user's arm, creating a sense of contact with the virtual model. A parametric tracing method is used which tracks the closest point on the surface.

Free Form Deformation (FFD) (Sederberg, T. W. and Parry, S. R., Free-form Deformation of Solid Geometric Models, SIGGRAPH'86, ACM Computer Graphics, pp. 151-160, 1986; Hsu, W., Hughes, J., and Khaufman, H., Direct Manipulation of Free-Form Deformations, Computer Graphics, SIGGRAPH'92, Chicago, pp. 177-184, July 1992), the disclosure of which is hereby incorporated by reference, is a powerful NURBS based technique for the deformation of free form surfaces or volumes. It introduces a deformation model called lattice that is represented by a trivariate volume regularly subdivided and defined by a 3D array of control points. The object to be deformed is embedded inside the lattice. The transformation is applied to the lattice and the embedded object is modified accordingly. But FFD is mainly used for global shape design, and is not efficient for local surface design.

Darrah et al. (Darrah, M., Kime, A., Scoy, F., A 3-D Lasso Tool for Editing 3-D Objects: Implemented Using a Haptics Device, Seventh Phantom Users Group Workshop, pp. 5-7, October 2002) have developed a convex hull approach for the selection of the non-planar voxels. This PHANToM™ device is employed to select a region for manipulation. The algorithm uses the voxels within the region to define a convex hull. Once the voxels within the convex hull have been identified, it can be modified easily.

Debunne et al. (Debunne, G., Desbrun, M., Cani, M., Barr, A. H., Dynamic Real-Time Deformations Using Space & Time Adaptive Sampling, Proceedings of the 28th Annual Conference on Computer Graphics and Interactive Techniques, pp. 31-36, August 2001), the disclosure of which is hereby incorporated by reference, have presented an adaptive technique for animating dynamic visco-elastic deformable objects using the PHANToM™ desktop. The virtual model consists of a continuous differential equation that is solved using explicit finite element method. The algorithm is based on the adaptive Green strain tensor formulation, which provides the dynamic behavior of the sculpted objects.

McDonnell et al. (McDonnell, K., Qin, H., and Wlodarczyk, R., Virtual Clay: A Real-time Sculpting System with Haptic Toolkits, Proceedings of the 2001 Symposium on Interactive 3D Graphics, March 2001) have developed a voxel-based modeling system based upon subdivision solids and physics based modeling. The dynamic subdivision solids respond to the applied forces in a natural manner. However, in this work also, the force input is provided through a PHANToM™.

Ehmann et al. (Ehmann, S., Gregory, A. and Lin, M., A Touch-Enabled System for Multiresolution Modeling and 3D Painting, Journal of Visualization and Computer Animation, pp. 145-158, 2000) have developed a system called the in Touch system for interactively editing and painting on a polygonal mesh using a PHANToM™ device. When touched by the PHANToM™ stylus, the meshes are divided into smaller ones to be displayed by surface subdivision method. After the user has modified the mesh, he or she can interactively paint the mesh surface at the point of contact of the stylus with the surface.

Balakrishnan et al. (Balakrishnan, R., Fitzmaurice, G., KurtenBach, G., and Singh, K., Exploring Interactive Curve and Surface Manipulation Using a Bend and Twist Sensitive Input Strip, 1999 ACM Symposium on Interactive 3D Graphics, pp. 111-118, 1999) have developed a device called ShapeTape for interactive NURBS curve and surface construction and manipulation. This device is a bend and twist sensitive strip, which can be used intuitively with both hands. Bend and twist are measured at 6 cm intervals by fiber optic bend sensors. By summing the bends and twists of the sensors along the tape, the shape of the tape relative to the first sensor can be reconstructed in real time. There is a one-to-one mapping between the tape and the NURBS curve.

The Rutgers Master II-ND Glove (Bouzit, M., Burdea, G., Popescu, G., and Boian, R., The Rutgers Master II-New Design Force-Feedback Glove, IEEE/ASME Transactions on Mechatronics, Vol. 7, No. 2, June 2002) has been developed at Rutgers for dexterous interaction with the virtual environment. The glove provides force feedback up to 16 N each to the thumb, index, middle and ring fingertips. It uses custom pneumatic actuators arranged in a direct-drive configuration in the palm. The direct-drive actuators make cables and pulleys unnecessary, resulting in a compact and lighter structure. The force-feedback structure also serves as position measuring exoskeleton by integrating noncontact Hall-effect and infrared sensors. The glove is connected to a haptic-control interface that reads its sensors and servos its actuators.

Mizuno et al. (Mizuno, S., Kobayashi, D., Okada, M., Toriwaki, J., Yamamoto, S., Virtual Sculpting with a Pressure Sensitive Pen, Proceedings of the SIGGRAPH 2003 Conference on Sketches & Applications: In Conjunction with the 30th Annual Conference on Computer Graphics and Interactive Techniques, July 2003) have devised a pressure sensitive pen for sculpting of virtual workpieces. The user operates the device like a normal pen to carve a workpiece in 3D space. The device is represented on the screen by a virtual chisel. The position of the chisel is decided when the user drags a mouse on the virtual workpiece displayed on the screen. The pressure applied by the user on the screen is transferred to the software as the carving depth, and the direction of the chisel motion indicates the carving angle to the surface.

Poon et al. (Poon, C. T., Tan, S. T., and Chan, K. W., Free-form Surface Design by Model Deformation and Image Sculpting, Proceedings of the 5th International Conference on Computer Applications in Production and Engineering, Beijing, China, pp. 90-101, 1995) have developed a new approach for local surface design that provides a rapid and intuitive way to create surface features on a parametric surface. Embossed or depressed patterns can be added to a surface, via a 2D grey-level image function. This 2D image function corresponds to a 2D elevation map of the surface. This approach allows the user to create surface features such as peaks and ridges by simply sketching over the model surface.

Blaskó et al. (Blaskó, G., and Feiner, S., An Extended Menu Navigation Interface Using Multiple Pressure-Sensitive Strips, 7th International Symposium on Wearable Computers (ISWC 2003), pp. 128-129, October 2003) have developed an input device comprising of four pressure-sensitive linear strips. The user places each of the four fingers of one hand on a corresponding strip. The capacitance value associated with each strip is a function of the finger contact area, which in turn is dependant on the amount of pressure applied by the user. However, this system has not been used for CAD modeling but as an advanced mouse to activate a multi-level 3D menu system.

U.S. Pat. No. 6,752,770, issued Jun. 22, 2004 to Mayrose et al., the disclosure of which is hereby incorporated by reference, as well as a presentation and paper by the inventors (Mayrose, J., Chugh, K., Kesavadas, T., A Non-invasive Tool for Quantitative Measurement of Soft Tissue Properties, Oral Presentation at the World Congress on Medical Physics and Biomedical Engineering, Chicago, June 2000; Mayrose, J., Chugh, K., Kesavadas, T., Material Property Determination Of Sub-Surface Objects In A Viscoelastic Environment, Biomedical Sciences Instrumentation, Vol. 36, pp. 313-317, 2000), the disclosure of which is hereby incorporated by reference, disclose a system for analyzing a region below one or more tissues.

The SensAble Technology's FreeForm™ modeling system uses PHANToM™ touch technology to allow sculptors and designers to model virtual objects on the computer using their sense of touch. It allows users to create 3D design concepts and share them as 3D models. It works as a 3D mouse and provides real time force and torque feedback to the user. However, this system is complex and relatively expensive. Accordingly, there is a need to provide a simpler, less inexpensive, yet powerful apparatus for manipulating NURBS models.

Intuitive surface design and deformation have been extensively studied in both CAD/CAM and computer graphics. Often, after the surface or object has been created, further modifications are necessary. One common way to modify the shape of a free-form surface is to modify its control points one at a time. However, the modification process becomes tedious if the surface or object is composed of a large number of patches with many control points. Accordingly, there is a need for interactive tools for manipulating a set of control points or sampled points in the case of complex sculptured surfaces.

Conceptual design is the initial stage of the design when the essential form or shape of a product is created. During this stage, the specification of the product shape is not rigidly defined and the designer has some freedom in determining the features of the product. Although the conventional modeling approaches are ideal for certain applications, they tend to fall short of offering designers the flexible and unified ability to represent and interactively manipulate the surface models.

The methods used for free-form curve and surface modification in current CAD systems are still limited and non-intuitive. For example, many tools used for manipulation of free-form curves and surfaces are mainly based on changing the mathematical parameters, which requires the user to have an additional understanding of the mathematical principles involved. Generally, designers, and especially concept designers, prefer tools such as clay models, which allow artistic and aesthetic design much more readily. Thus the most natural tool for a designer is his or her hand.

### DISCLOSURE OF THE INVENTION

With parenthetical reference to the corresponding parts, portions, or surfaces of the disclosed embodiment, merely for the purposes of illustration and not way of limitation, the present invention provides an apparatus (15) for interfacing between an operator (26) and computer generated virtual object comprising a force sensor (19) that provides a force signal as a function of the amount of force applied to a representative physical body (22), a position sensor (18) that provides a position signal representative of the location of the position sensor when the force is applied, an article (16) for coupling the force sensor and the position sensor to an extremity of an operator, and a processor system (20) communicating with the force sensor and the position sensor and adapted to deform a virtual object (24) as a function of the force signal and the position signal.

The physical body may comprise a deformable material and the deformable material may be clay or may be selected from a group consisting of a table top, a pad and a ball. The apparatus may comprise additional position sensors and force sensors. The article for coupling the force sensor and position sensor may comprise a glove having multiple fingers (17) and the force sensors and position sensors may be supported by the glove. The article for coupling the force sensor and position sensor to an extremity of an operator may comprise a stripe of material configured to wrap around a finger of the operator or an exoskeletal device adapted to be supported by a hand of the operator. The virtual object may be a three dimensional object. The deformation of the virtual object may be a function of predetermined properties of the virtual object.

In another aspect, the invention provides a method of modeling a parametric surface comprising the steps of defining control points (36) of a virtual object (24), defining properties of the control points, providing a physical device (16) having a force sensor (19) that provides a force signal and position sensor (18) that provides a position signal, providing a physical body (22), moving the device relative to the body, reading the force signal from the force sensor and the position signal from the position sensor, processing (20) the force and position signals to select one or more control points in corresponding force vectors (38), the force vectors being a function of the force and position signals, providing a virtual representation (24) of the object, displaying the virtual representation of the object on the display (21), providing a virtual representation of a deformation (39) of the object is a function of the process signals and the properties of the control points, and displaying the virtual representation of the deformation on the display.

The method may further comprise the steps of providing a virtual representation (25) of the physical device and displaying the virtual representation of the device on the display. The physical device may be any material removal or modification tool and may be selected from a group consisting of a probe, a finger, a knife, a stamp, a pestle, a hammer and a sculpting tool, and the virtual representation may be any material removal or modification tool and may be selected from a group consisting of a probe, a finger, a knife, a stamp, a pestle, a hammer and a sculpting tool. The properties of the control points may be selected from the group consisting of softness, stiffness, elasticity, viscosity, hardness and stretchiness. The step of defining control points may comprise entering control points manually or entering dimensions of the object and computing the control points from the dimensions.

Accordingly, the general object of the present invention is to provide an improved apparatus for interfacing between an operator and a visual object for computer aided design applications.

### BRIEF DESCRIPTION OF THE DRAWINGS

FIG. 1 is a schematic of the system for interfacing between an operator and a computer generated virtual object.

FIG. 2 is a perspective view of the system shown in FIG. 1.

FIG. 3 is a perspective view of three representative virtual tools.

FIG. 4 is a schematic view of the display shown in FIG. 2.

FIG. 5 is a cross-sectional view of a NURBS block with deformation.

FIG. 6 is a control vector, as a function of force and position.

FIG. 7 is a force displacement graph showing variations in the displacement behavior of control points for a NURBS block.

FIG. 8 is a block diagram of the simulation loop for deforming the modeled object.

FIG. 9 is an example of the modeling of a car hood using the system shown in FIG. 1.

FIG. 10 is a view of the NURBS block shown in FIG. 5 before deformation or sculpting and with and without the control points for the surface displayed.

### DESCRIPTION OF THE PREFERRED EMBODIMENTS

At the outset, it should be clearly understood that like reference numerals are intended to identify the same structural elements, portions or surfaces, consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

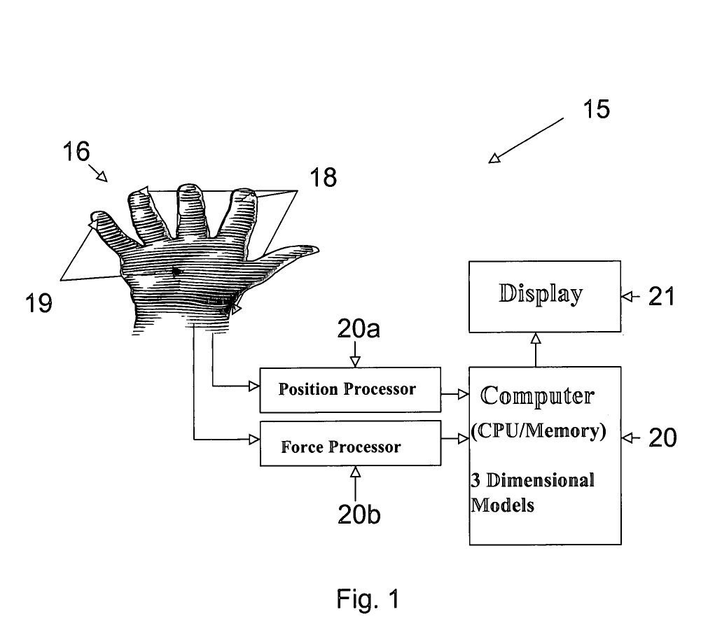

Referring now to the drawings, and more particularly to FIG. 1 thereof, the preferred embodiment of a system for interfacing between an operator and a computer generated virtual object for computer aided design applications is generally indicated at 15. As shown in FIG. 1, system 15 generally includes a tactile based CAD modeling glove 16 having multiple pressure sensors 19 and position sensors 18 communicating with a processor 20. A display 21, in communication with processor 20, is used to capture the motion of the designer's, user's or operator's hand 26, including pressure and position of the fingers, and to reflect such motion in deforming or modifying a computer generated virtual object 24. The goal behind system 15 is to provide designers with a tool that will allow them to touch, push and manipulate virtual objects, just as they would with clay models or sculptures. System 15 allows for a virtual block or body 24 to be deformed in a physically realistic manner in response to user's 26 direct manipulation of a hard or soft real physical object 22. The dynamic behavior of the NURBS model or block 24 in response to the force and position input obtained from model glove 16 produces highly natural shape variations.

The software for the preferred embodiment of modeling system 15 is in C++ using Visual Studio 6.0 as the compiler. The graphical user interface (GUI) for the software is in C++ on the OpenGL platform using GLUI libraries. The on-screen GUI controls sculpting parameters and provides visual feedback about the position and the force/position applied by user 26. GLUI is a conventional GLUT based C++ user interface library which provides controls such as buttons, checkboxes, radio buttons, spinners for interactively manipulating the variables, separators, editable text boxes, and panels.

In system 15, a NURBS surface representation is created that helps the designer 26 to modify an existing free-form surface 24 (parent surface) in a natural and intuitive manner. The NURBS surface block 24 is initially constructed using OpenGL NURBS evaluators. The surface is structured in such a manner that the control points 36 of the block are updated dynamically in response to the force applied by the designer 26 in real life. The new surface is generated by adding a displacement function to the parent surface. The overall deformation 31 of the parent surface can be viewed as the weighted average of the control vectors 38. Real time update of the NURBS block 24 using glove 16 provides a highly interactive feeling to the user 26. The user 26 defines a point on the NURBS surface. Depending upon his or her choice of tool 25, the force applied and the position, the surface is locally deformed within the specified influence radius of the tool tip. The sculptured NURBS object 24 is rendered using OpenGI on a high-end 3DS Labs graphics accelerator. System 15 can run on a Microsoft Windows NT PC with a dual processor Pentium III with 1 GHz CPU and 512 MB RAM.

The results obtained using system 15 show that system 15 can be used to model fairly complex NURBS surfaces with little or no knowledge about the modeling or computer programming. System 15 has the potential of being a useful tool for artists and designers involved in modeling complex 3D sculpted objects. User interaction with the CAD software using simple intuitive model glove 16 increases the realism of the design process and hence can also be used in virtual prototyping environments. The model glove 16 is based on the input system developed by Mayrose et al. (Mayrose, J., Chugh, K., Kesavadas, T., Material Property Determination Of Sub-Surface Objects In A Viscoelastic Environment, Biomedical Sciences Instrumentation, Vol. 36, pp. 313-317, 2000), the disclosure of which is hereby incorporated by reference, for measuring biomedical tissue properties. The disclosure of U.S. Pat. No. 6,752,770 is also hereby incorporated by reference.

Using model glove 16 as an input device, a new NURBS based surface representation model for users to modify in a natural and intuitive manner is provided. The new surface is generated by manipulating a set of control points 36 based on the position and force applied using model glove 16. The displacement function is controlled by a set of key points that define the blending functions and a set of control vectors 38 that are blended to form the final shape. The overall deformation 31 of the parent surface can be viewed as the weighted average of control vectors 38. The deformation of the surface is nominally based on physical laws. Through a computational physics simulation, the model responds dynamically to applied simulated forces in a natural and predictable way.

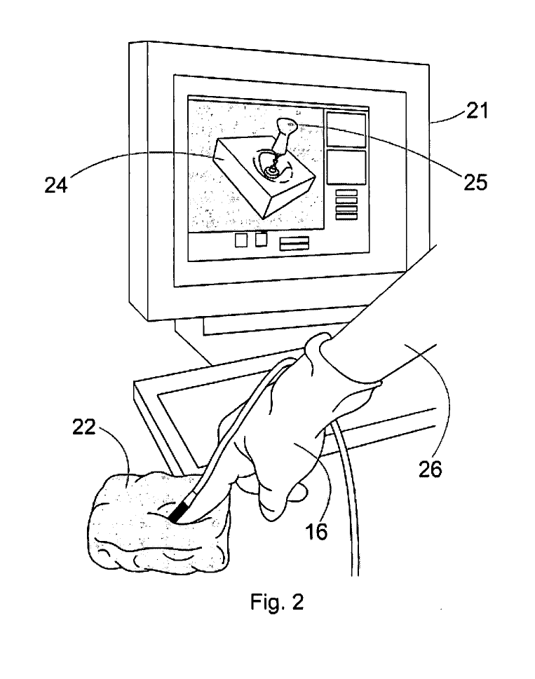

As shown in FIGS. 1-2, model glove 16 comprises a position sensor 18 at the tip of one finger, which senses the movements of such finger, and a force or pressure sensor 19 that reads the force data from the same finger tip. The position and force characteristics of the finger are tracked in real time and displayed graphically on a CAD modeling environment and display 21.

The magnetic position sensor 18, placed on the fingernail, tracks the movement of the finger in six degrees; namely the translations along 3 axes and roll, pitch, and yaw about such axes. Sensor 18 has a range of 30 inches. The small size of sensor 18 allows the user to push deep into the non-metallic object of study 22 without interfering with its surface. A miniBIRD™ position sensing unit, manufactured by Ascension Technology of Burlington, Vt. may be used as position sensor 18 in the preferred embodiment. This sensor is a six degrees-of-freedom measuring device that is used to measure the position and orientation of a small sensor in reference to the transmitter. It is a DC magnetic tracking device and comprises of an electronics unit, power supply, a standard range transmitter, and a sensor. In the preferred embodiment, sensor 18 is 18 mm×8.1 mm×8.1 mm in size, and provides highly accurate position and orientation results. The sensor is capable of making 30 to 144 measurements per second of its position and orientation when it is located within ±30 inches of its transmitter. Sensor 18 determines position and orientation by transmitting a pulsed DC magnetic field that is measured by its sensor. From the measured magnetic field characteristics, sensor 18 computes its position and orientation and makes this information available to computer 20.

Several sensors can be hooked together. A miniBIRD™ and Fast BIRD Bus (FBB), manufactured by Ascension Technology of Burlington, Vt. may be used in the preferred embodiment to form this configuration. In this configuration, sensors from up to 126 miniBIRDs™ can be simultaneously tracked by a single transmitter. Each miniBIRD™ unit in the configuration contains two independent serial interfaces. Processor 20a may utilize either a single or multiple RS232 interfaces to command and receive data from all such units. Processor 20a can send commands and receive data from any individual units because each unit is assigned a unique address on the FBB via back-panel dip switches. The units can be configured to suit the needs of many different applications: from a standalone unit consisting of a single transmitter and sensor to more complex configurations consisting of various combinations of transmitters and sensors. In the preferred embodiment, only a few miniBIRD™ sensors 18 have been used. More sensors can be added later to each finger of glove 16 for a more intuitive interaction with the virtual model.

Force sensor 19, which is located on the finger-pad, collects data on the applied load from 0-25 lbs, although a low range force sensor may be used that is more sensitive to small forces. In the preferred embodiment, force sensor 19 is 0.003 inches thick, which is similar to that of most latex gloves worn by medical professionals. The thinness of the sensor allows the user 26 to retain their sense of touch during the molding or sculpting process, while simultaneously recording the force applied to the physical model or body 22. Sensors 18 can be programmed to collect data from 1-200 Hz, depending on the application. Force sensor 19 measures the force applied by the user 26 in real life. The Tekscan FlexiForce™ unit manufactured by Tekscan Inc. of South Boston, Mass. may be used in the preferred embodiment. In the preferred embodiment, sensor 19 has a flexible printed circuit. It is 0.55″ (14 mm.) wide and 9.0″ (229 mm.) in length. The active sensing area is a 0.375″ diameter circle at the end of the sensor. Sensor 19 is constructed of two layers of substrate, such as a polyester film. On each layer, a conductive material (silver) is applied, followed by a layer of pressure-sensitive ink. Adhesive is then used to laminate the two layers of substrate together to form the sensor. The active sensing area is defined by the silver circle on top of the pressure-sensitive ink. Silver extends from the sensing area to the connectors at the other end of the sensor, forming the conductive leads. The sensor acts as a variable resistor in an electrical circuit. When the sensor is unloaded, its resistance is very high (greater than 5 Meg-ohm); when a force is applied to the sensor, the resistance decreases. This resistance is read, and an 8-bit analog-to digital converter changes the output to a digital value in the range of 0 to 255. The sensor's tab is placed into the sensor handle. The handle is made of plastic, and it contains a processor 20b, which gathers data from the sensor, processes it, and sends it to computer 20 through a serial port. Force sensor 19 can be programmed to collect data from 1-200 Hz, depending on the application.

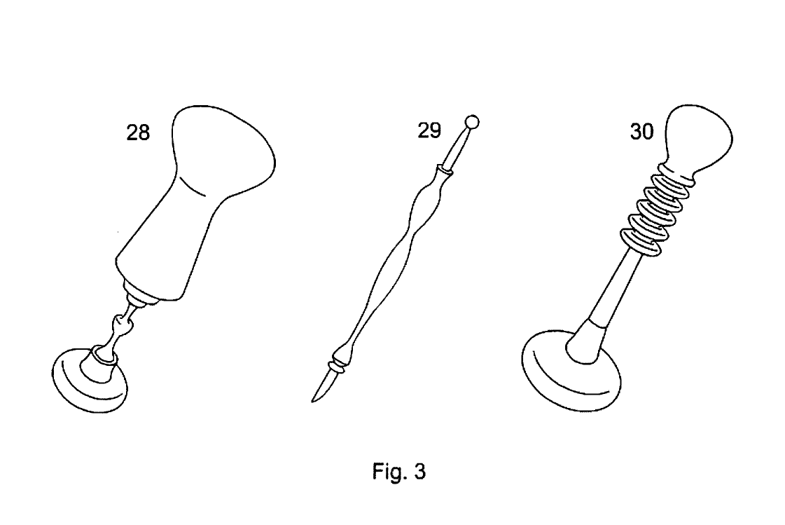

On computer display 21, the user's finger is represented as a virtual tool 28-30. The position sensors sense the movement of the hand, and interface those movements with the selected virtual tool 28-30. The force sensors 19 capture the magnitude of the force exerted by user 26. As shown in FIG. 3, a choice of different tools 28-30 may be provided to allow intuitive and precise surface manipulation. As shown in FIG. 3, three virtual tools are used in the preferred embodiment; a sharp point tool 29 for fine carving and making small deep holes, a medium size ball 28 for gauging or molding, and a large diameter tool 30 for large area or rough deformation of surfaces.

To provide precise force input, the user may be provided with several objects 22 to touch, feel and deform, such as a flat solid tablet, playdough, spherical balls of different softness, or clay. Other physical objects may also be used depending on the application. When the user 26 touches and applies pressure on one of these physical objects 22, the position of the fingertip, the applied force and time are collected and stored in a database. This data is then used to calculate the speed of fingertip motion. After the virtual surface 24 has been created (as described below), subsequent modifications can be implemented onto the generated surface by modifying the control points 36 which govern the shape of the surface 24.

Non-uniform Rational B-splines, or NURBS, are commonly used geometric primitives. NURBS allow the precise specification of free-form curves and surfaces as well as more traditional shapes, such as conics or quadrics.

A Nonuniform Rational B-spline [3] surface of degree (p, q) is defined by the equation (1):

$$S ( u , v ) = \frac{{\sum }_{i = 0}^{m} {\sum }_{j = 0}^{n} {N}_{i , p} ( u ) ⋆ {N}_{j , q} ( v ) ⋆ {w}_{i , j} ⋆ {P}_{i , j}}{{\sum }_{i = 0}^{m} {\sum }_{j = 0}^{n} {N}_{i , p} ( u ) ⋆ {N}_{j , q} ( v ) ⋆ {w}_{i , j}} \qquad ( 1 )$$

where N_{i,p} and N_{j,q} are the B-spline basis functions, P_{i,j} are the control points, and the weight w_{i,j} of P_{i,j} is the last ordinate of the Homogeneous Point P_{i,j}^{w}. Associated with the surface are two knot vectors U={u₀u₁,K,uᵣ} and V={v₀,v₁,K,vₛ}, where r=n+p+1 and s=m+q+1.

Changing a control point Pᵢ or a weight wᵢ only affects the curve on the interval u=(uᵢ, uᵢ₊ₚ₊₁), which provides local control over the shape of the curve. Local control exists for surfaces as well. Modifying a control point P_{i,j} or a weight w_{i,j} affects only the portion of the surface in the rectangle [uᵢ,uᵢ₊ₚ₊₁]×[vⱼ,v_{j+q+1}]. Finally curves and surfaces are infinitely differentiable on the interior of knot spans and p-k times differentiable at a knot of multiplicity k.

In the proposed modeling system 15, a NURBS surface representation is created that helps the user to modify an existing free-form surface 24 (parent surface), in a natural and intuitive manner. A preset NURBS surface block is initialized at the start of the program using OpenGL NURBS evaluators. The surface is structured in such a manner that the control points 36 of the block are updated dynamically in response to the force applied by the designer 26. The NURBS surface is updated in real time by adding a displacement function to the parent surface. The overall deformation 31 of the parent surface 24 can be viewed as the weighted average of the control vectors 38. The designer 26 defines a point on the NURBS surface. Depending upon his or her choice of tool 28-30, the force applied and the position, the surface is deformed within the specified influence radius of the tool tip. The influence radius of the virtual tool 25 can be defined as the radius of an imaginary sphere located at the tool tip. The control points 36 which lie within this sphere are influenced by the force applied by the user.

The magnitude of deformation of each control point 36 is inversely proportional to its distance from the center of the tool tip and proportional to the total force applied. The less distance from the center and the higher the force applied, the more the displacement of the control point 36.

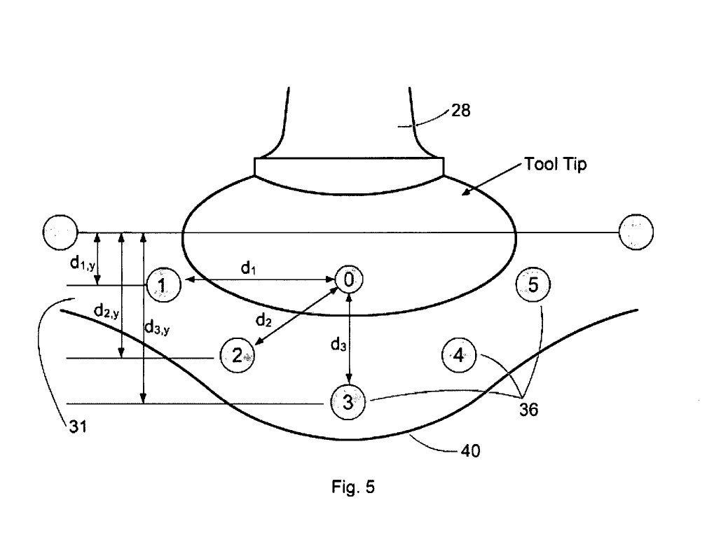

The FIG. 5 shows a cross sectional view of the deformation process for a single B-spline curve 40. The control points 1, 2, 3, 4, 5 lie within the influence radius of the tool tip R.

The distance dᵢ for a control point i from the tool tip, can be given as
dᵢ=\sqrt{(d₀ₓ−dᵢₓ)²+(d_{0y}−d_{iy})²+(d_{0z}−d_{iz})²}

As seen in the FIG. 5, the y component of the displacement increases with the decrease in proximity of the control point to the tool tip. The amount of deformation brought about by the tool 28-30 varies with the influence radius R associated with each tool, as well as the material properties assigned to the NURBS block. The greater the stiffness, the less the displacement of the control points for the same magnitude of force. The three virtual tools used in the preferred embodiment are shown in shown in FIG. 3. In the preferred embodiment, tool 28 has an influence radius of 1.5, tool 29 has an influence radius of 0.5 and tool 30 has an influence radius of 4.0.

Editing a NURBS surface with glove 16 requires that both the force and position sensors 18, 19 be connected to the user's computer 20. To modify the control point using glove 16, the user 26 moves his or her hand to the desired location in the real world. The physical object 24 is mapped to the virtual object 22 on a 1:1 scale to provide an intuitive feel. When the user presses at the appropriate location on the physical block 22, the local region of the virtual block 24 experiences the force exerted by the user. The size of the local region depends upon the influence radius of the tool. The user 26 can sculpt the NURBS block in a desired fashion based on his or her choice of tool 28-30. The virtual tool 28-30 presses against the NURBS block and modifies it in the same fashion as a real block would. While the NURBS control points 36 are being moved, the surface is recalculated and redrawn continuously. The contact position of physical glove 16 with respect to the virtual tool may be reset as desired (e.g., when the glove is out of range of the virtual workspace, just as the cursor position can be reset by lifting a mouse and placing it on the table again). This process can be repeated by the designer to reach all the desired positions of the workspace of the virtual object 22.

As shown in FIG. 5, the cross section of the NURBS block can be considered to be a grid of several NURBS curves 40. Any change in the control points associated with the NURBS curve eventually results in a local or global modification or deformation 31 of the NURBS surface depending upon the influence radius of the tool tip. To strike a balance between modeling accuracy, and computational efficiency, the preferred embodiment enables 16 curves in each of the u and v directions of the NURBS surface patch forming a 16×16 grid. Each of these curves has 16 control points governing its shape.

The equation of each NURBS curve is as follows:

$$C ( u ) = \frac{{\sum }_{i = 0}^{n} {N}_{i , p} ( u ) ⋆ {w}_{i} ⋆ {P}_{i}}{{\sum }_{i = 0}^{n} {N}_{i , p} ( u ) ⋆ {w}_{i}} , \qquad ( 2 )$$

where p is the degree, N_{i,p} is the B-spline basis functions, Pᵢ are the control points, and the weight wᵢ of Pᵢ is the last ordinate of the homogeneous point Pᵢ^{w}.

The modification of the NURBS surface is performed by modifying the location of the control point. The control point modification is affected by two actions of glove 16. First, the position of the finger tip is obtained from the position sensor 18 and it is correlated to the nearest control point. The distance between the actual control point and the position of the finger tip is calculated. Secondly, two successive positions of glove 16 are used to compute a direction of the vector 38, while the magnitude of the vector 38 is obtained by the force sensor 19. The amount of the change of the control point is proportional to the force. The force F applied by operator 26 using glove 16 can be given by the basic equation:
F=k×+Cx
where k is the stiffness, x is the displacement, C is the damping coefficient associated with the material and x′ is the velocity imparted to the moving mass point.

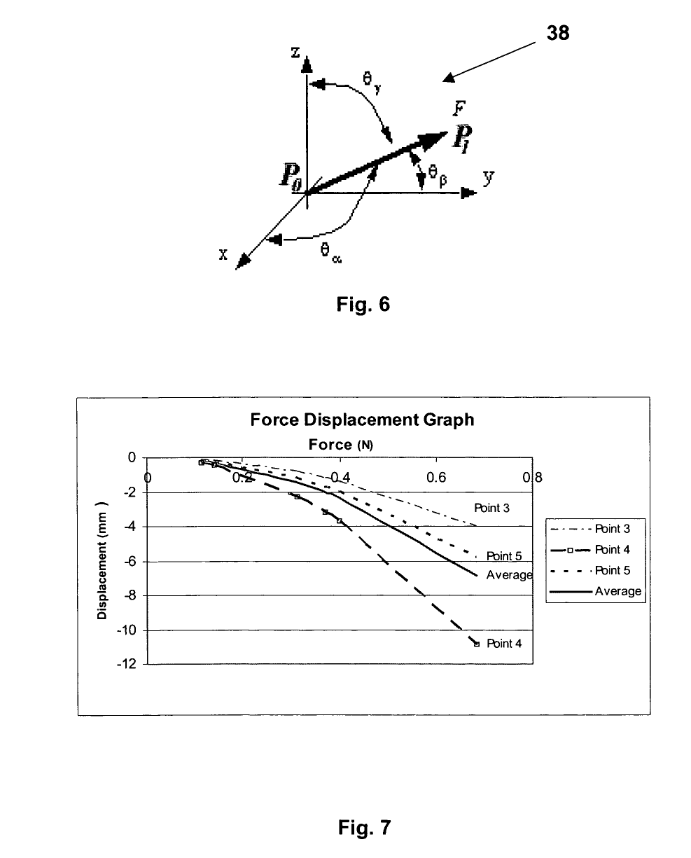

For a non-elastic solid, the damping coefficient can be neglected. The actual displacement of the control points is governed by the direction of the vector of the force, which in turn is governed by the motion of glove 16 at the instant of force application. As show in FIG. 6, let P₀ be the initial position of the tool tip, and P₁ be the position of the tool tip after a time interval of t sec. The angles made by the tool with the 3 axes are measured using the position sensor 18.

If θ_{α}, θ_{β}, θ_{γ} are the angles made by the tool with the X, Y and Z axes of the NURBS surface, the corresponding force components can be given as:
Fₓ=Cos(θ_{α})*|F|,
F_{y}=Cos(θ_{β})*|F|,
F_{z}=Cos(θ_{γ})*|F|,

The displacement of the control point Pᵢ can now be computed as:

$$\partial {P}_{ix} = \frac{{F}_{x}}{k} , \\ \partial {P}_{iy} = \frac{{F}_{y}}{k} , \\ \partial {P}_{iz} = \frac{{F}_{z}}{k}$$

where k can be considered as a constant (stiffness) based on the properties of the physical object 22 used for manipulation. Updating the increments in the position of the control points in the equations (1) and (2), the new position of the control point is calculated in real time, and the surface is modified accordingly.

The variations in the displacement behavior of the control points that lie within the influence radius of the sphere can be observed in the force displacement graph shown in FIG. 7. The tool is located closer to the control point 4, than points 3 and 5. As the magnitude of force is increased, the displacement of the control point, which is closest to the virtual finger, is observed to be more than the displacement of control points 3 or 5. The combined effect of the surface deformation hence is a function of the force applied, and blending weighted functions obtain by the control points in the sphere of influence of the virtual tool.

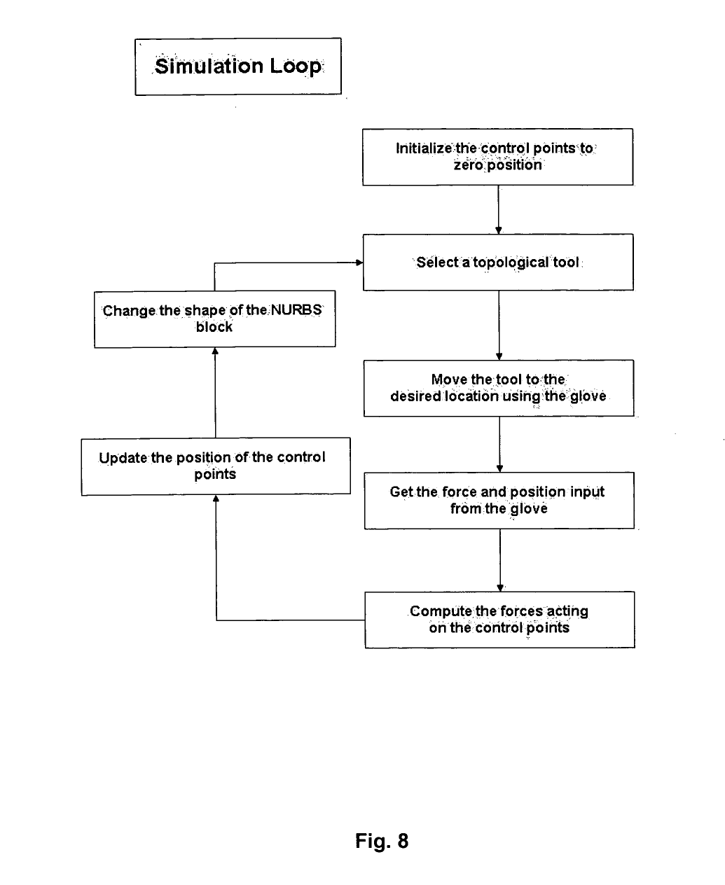

Initially all the control points are set to zero. Then the system runs in a loop as shown in FIG. 8 and continuously updates the physical state of the modeled object 24. The simulation loop traverses through the control points and computes the total internal forces acting on the points. External forces are queried from glove 16 attached to computer 20. The acceleration and velocity of the control lattice are then computed in order to move the control lattice to its new position. The virtual sculpted surfaces can be updated at an interactive frame rate of 20+frames per second, but a higher level of subdivision on the surface may degrade this performance. Surfaces can be edited in a wire frame mode, or in a shaded surface mode.

As mentioned above, the graphical user interface (“GUI”) for the software in the preferred embodiment is in C++ on an OpenGL platform using GLUI libraries. The on-screen GUI controls sculpting parameters and provides visual feedback about the position and the force/position applied by the user. The sculptured object was rendered using OpenGl on a 3DS Labs graphics accelerator.

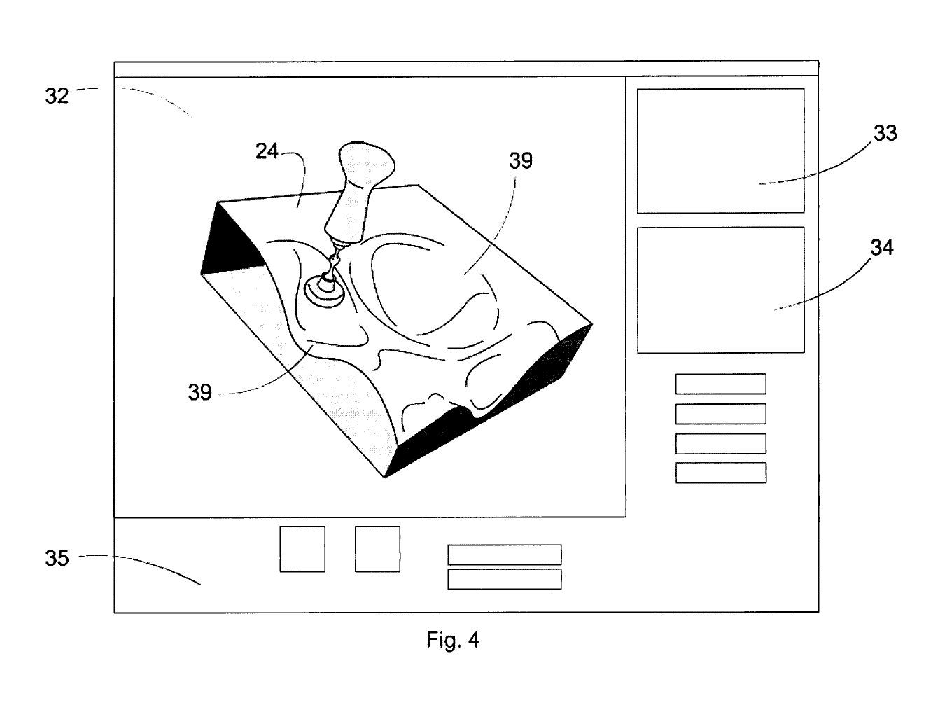

The visual interface or display 21 of the software is as shown in FIG. 4. This GUI comprises 3 windows 32, 33, 34 and a GLUI control. The main window 32 is known as the workspace window and it shows the NURBS block 24 on which the modeling process is carried out. The hand of the designer 26 wearing the glove 16 is mapped onto the window as a modeling tool 28. The motion of tool 28 and the deformation 31 of the NURBS block is updated in workspace window in real time.

This window may also display the current deformation mode for the user in the bottom right corner (not shown). The first mode is a discrete mode. In this mode, designer 26 models the NURBS block by applying force to key points for getting surface deformation at those points. Once he/she applies the force, the surface block 24 deforms appropriately. When the surface block 24 attains equilibrium state, the tool 28 comes back to it's neutral position, which is a plane hovering above the surface block 24. The designer 26 can now move the tool freely to a new spot on block 24 where deformation is desired. The design process takes place in discrete steps. The second mode is a continuous mode. In this mode, once the designer applies an initial force, and the force remains associated with the tool at all instants of time. The designer can now drag the tool 28 over the surface to get a smooth continuous deformation. When he/she desires to stop the continuous deformation, he/she can press the key ‘k’ on the keyboard. This key is used to toggle between the two modes.

The second window 33 is known as the information window, and is located at the right top of display 21. This window displays the material name, the instantaneous force applied onto the material, the mean displacement of the control points and the stiffness of the material of block 24.

The third window 34 is called the instructions window. As the name suggests, this window displays a list of instructions to be followed by the designer 26 during the modeling process, such as press the deformation button to get the instantaneous value of the force and press the control points to toggle between the display of control points 36 and non-display of control points 36, as shown in FIG. 10. The user can also invoke an active graph window in place of the instructions window by pressing a “show graph” button. The active graph window when invoked shows a force-displacement graph that illustrates the characteristic behavior of the surface material in response to the forces applied by user 26.

In the preferred embodiment, the GUI may be provided with additional panels in order to impart more functionality to the software. For example, a panel may be provided with spinners for interactively rotating the entire design space, and a rotating blue colored point light may be provided in addition to ambient lighting. Click and drag buttons may be provided to pan and zoom the NURBS block 24. A “show control points” button may be used to toggle the display of the control points. When the user 26 presses glove 16 against a surface 22, in the preferred embodiment, he or she has to simultaneously click the “show deformation” button to pass the force variable to the software. As soon as this button is pressed, the NURBS surface gets locally deformed and updated in real time.

An additional panel of the GUI may include a “plot graph” button that toggles between the instruction window and the graph window. A “save data” button may save the current NURBS surface information (the force applied, the control points information, and knot vector values) as a text file, and export the surface in a 0.3 dm (Rhino™) format. A “toggle display” button toggles between wireframe and smooth shaded modes. When the NURBS surface is being modified by the user, the “save animation” button is used to get screenshots of the workspace window in a jpeg format. The screen shots are taken at a frequency of 4 frames per second. This facility has been provided by using the Intel jpeg library. Screen captures in the jpeg format help to keep the image size low, by compromising a bit on the image resolution. These images can be stitched together to get a continuous animation, using commercial software. Radio buttons can be provided to help the user assign different materials and properties to the NURBS block 24 before the start of the design process.

Models designed using the proposed system can be saved and exported into commercial CAD package Rhino™ model (0.3 dm). This export functionality is enabled using the openNURBS™ toolkit, which is a library that reads and writes openNURBS™ 3-D model files (0.3 dm). In addition, the openNURBS™ Toolkit provides NURBS evaluation tools and elementary geometric and 3d view manipulation tools. The 3 dm file format is ideally suited for NURBS surface models as it stores the model information as discrete control points, knot points, degree and weights. This enables easy data transfer to and from Rhino™ modeler. It is contemplated that the data will be transferred to a neutral format to be compatible with other commercial CAD packages.

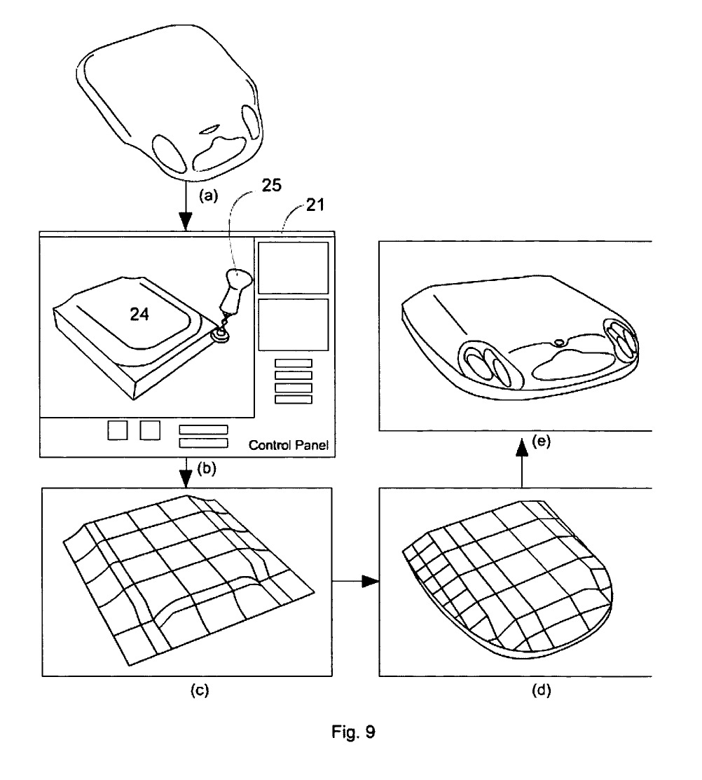

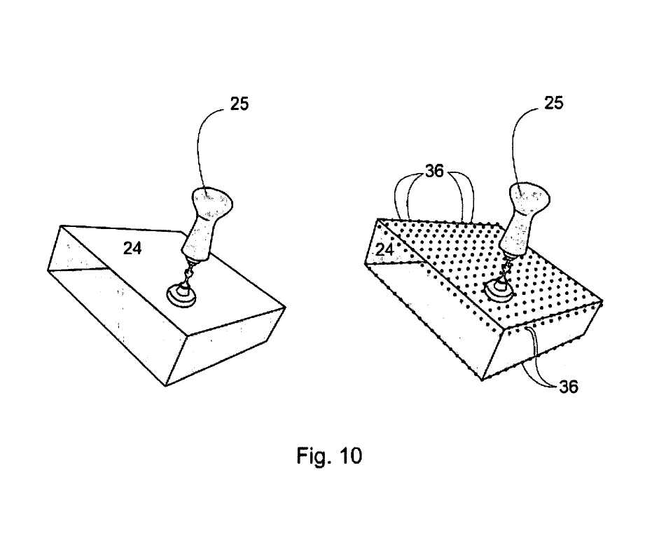

Using system 15, several complex surfaces can be modeled. The surface blocks were created using three different virtual tools attached to glove 16. Finished models were rendered in Rhino™ using a Flamingo Raytracer™. FIG. 9 shows an example of a complete product cycle of a car hood. Modeling system 15 may be used as a computer aided industrial design tool. It is capable of taking the designer right from the initial concept sketch 10(a) to the prototype of the object 10(e). All the intricate details of the hood are designed using the modeling system 15. Once the hood design is completed, it can be exported to the Rhino™ CAD system, and further trimming operations carried out. Other visual artifacts can be added to the model for further enhancements.

System 15 is thus a new NURBS modeling system and method along with a unique force-position input device that can be worn by a designer like a glove. System 15 allows easy manipulation of surfaces by mimicking the process of an artist molding a clay object. The results obtained using this system show that system 15 can be used to model fairly complex NURBS surfaces with little or no knowledge about modeling or computer programming. The sculpting system can be a useful tool for artists and designers involved in modeling complex 3D sculpted objects. User interaction with the CAD software using the simple intuitive glove system 15 increases the realism of the design process and hence can also be used in virtual prototyping environments.

Glove 16 can be extended to include additional force and position sensors on the palm and two other fingers to provide more flexibility to the designer. A robust 3D solid modeling package based on physically based models interfaced with the proposed input device can also be provided.

While a NURBS based system may be used in the preferred embodiment, computational power is now sufficient enough to enable us to solve mechanical systems in real time using computational techniques. Finite element is one of the most popular discrete methods of solving real life problems that arise in areas of heat transfer, fluid mechanics and mechanical systems in general. As an alternative, a finite element method (FEM) based system may be used to simulate deformation of objects to reflect behavior of various natural and artificial materials such as clay, plastic, metal etc. using a computer.

Behavior of such solid material can be completely represented using a set of three equations as follows:
1) Stress-strain equation
2) Equilibrium equation
3) Conservation of mass equation
   For simple shapes, one can solve the above set of equations and come up with analytical solutions, but with complex geometries it is not always possible to obtain exact analytical functions that represent the system.

The easiest approach to show a material deformation under external forces is to just calculate deflections at the point on the surface that is in contact with the force agent. Although this method is computationally inexpensive and visually appealing, when the force applied exceeds a certain amount, the effect of non-conservation of volume becomes prominent and one can witness the volume shrinking abruptly. It also completely ignores boundary conditions. Other popular techniques of using “spring-mass-damper” structures to represent the whole material volume can simulate deformations well by taking into account the boundary conditions, and equilibrium conditions but it fails to ensure conservation of mass.

A FEM technique gives better results than the above two methods because they account for all the three principle equations. Apart from finite element, other discrete solution methods are finite difference and finite volume. A finite element method uses elements that bound a volume of material. These elements are connected to each other through nodes. Finite difference method also uses nodes but they don't bind any volume. The connectivity is of an interlocking type as between bricks of an arc bridge. Finite element technique addresses the issue of arbitrary shapes being loaded by arbitrary forces subject to arbitrary boundary conditions very well. As mentioned above, the availability of faster computers has made it possible to solve mechanical systems in a very straightforward way (using finite element) rather than relying upon indirect methods that use too many simplifications and are hard to generalize. In this alternative, the user applies pressure using glove 16 on a surface closely matching a real object such as a playdough, and the FEM software computes the deformation on the virtual object and displays the deformation on computer screen 21.

The present invention contemplates that many changes and modifications may be made. Therefore, while the presently-preferred form of the modeling system has been shown and described, and several modifications thereof discussed, persons skilled in this art will readily appreciate that various additional changes and modifications may be made without departing from the spirit of the invention, as defined and differentiated by the following claims.

What is claimed is:

1. An apparatus for interfacing between an operator and a computer generated virtual object comprising;
a force sensor that provides a force signal as a function of the amount of force applied to a representative physical body;
a position sensor that provides a position signal representative of the location of the position sensor when said force is applied;
an article for coupling said force sensor and said position sensor to an extremity of an operator;
a processor system communicating with said force sensor and said position sensor and adapted to deform a virtual object as a function of said force signal and said position signal.

2. The apparatus set forth in claim 1, wherein said body comprises deformable material.

3. The apparatus set forth in claim 2, wherein said deformable material is clay.

4. The apparatus set forth in claim 1, wherein said body is selected from a group consisting of a table top, a pad and a ball.

5. The apparatus set forth in claim 1, and further comprising at least one additional position sensor and at least one additional force sensor.

6. The apparatus set forth in claim 5, wherein said article comprises a glove having multiple fingers and said force sensors and said position sensors are supported by said glove.

7. The apparatus set forth in claim 1, wherein said article comprises a strip of material configured to wrap around a finger of said operator or an exoskeletal device adapted to be supported by a hand of said operator.

8. The apparatus set forth in claim 1, wherein said virtual object is a three dimensional object.

9. The apparatus set forth in claim 1, wherein said deformation is a function of predetermined properties of said virtual object.

10. A method of modeling a parametric surface comprising the steps of:
defining control points of a virtual object;
defining properties of said control points;
providing a physical device having a force sensor that provides a force signal and a position sensor that provides a position signal;
providing a physical body;
moving said device relative to said body;
reading said force signal from said force sensor and said position signal from said position sensor;
processing said force and position signals to select one or more control points and corresponding force vectors, said force vectors being a function of said force and position signals;
providing a virtual representation of said object;
displaying said virtual representation of said object on a display;
providing a virtual representation of a deformation of said object as a function of said processed signals and said properties; and
displaying said virtual representation of said deformation on said display.

11. The method set forth in claim 10, and further comprising the steps of providing a virtual representation of said physical device and displaying said virtual representation of said device on said display.

12. The method set forth in claim 10, wherein said physical device is selected from a group consisting of a probe, a finger, a knife, a stamp, a pestle, a hammer and a sculpting tool.

13. The method set forth in claim 11, wherein said virtual representation is selected from a group consisting of a probe, a finger, a knife, a stamp, a pestle, a hammer and a sculpting tool.

14. The method set forth in claim 10, wherein said properties of said control points are selected from a group consisting of softness, stiffness, hardness, elasticity and viscosity.

15. The method set forth in claim 10, wherein said step of defining control points comprises entering control points manually or entering dimensions of said object and computing said control points from said dimensions.

16. The method set forth in claim 11, and further comprising the step of defining at least one property of said virtual representation of said device and wherein said virtual representation of said deformation of said object is a function of said property of said virtual representation of said device.
